(19) United States
(12) Patent Application Publication
(10) Pub. No.: US 2014/0063858 A1
(43) Pub. Date: Mar. 6, 2014

(54) Supply voltage control

(71) Applicant: Juergen Mack, Goeppingen (DE)

(72) Inventor: Juergen Mack, Goeppingen (DE)

(21) Appl. No.: 14/003,152

(22) PCT Filed: Feb. 1, 2012
(86) PCT No.: PCT/EP2012/051660

§ 371 Date: Nov. 8, 2013

(30) Foreign Application Priority Data
Mar. 11, 2011 (DE) 10 2011 005 416.2

(51) Int. Cl. H02H 7/12

(52) U.S. Cl. CPC H02H 7/1213
USPC 363/16

(57) ABSTRACT

A disconnect device for a switched-mode power supply, including an activation device for a first transistor for generating a transformable voltage. The device includes a second transistor of the PNP type and a third transistor of the NPN type, the base of the second transistor being connected to the collector of the third transistor and the base of the third transistor being connected to the collector of the second transistor. The emitter of the third transistor is connected to ground. The emitter of the second transistor is connected to a control voltage terminal of the activation device, the control voltage terminal being configured for suppressing the generation of the voltage by the first transistor, if the control voltage terminal is connected to ground, so that the generation of the voltage is suppressed if the base of the third transistor is acted upon by a voltage exceeding a predetermined threshold value.

### FIELD OF THE INVENTION

The present invention relates to a circuit for providing a supply voltage. In particular, the present invention relates to an electronic circuit for providing a supply voltage for charging an electrical energy store.

### BACKGROUND INFORMATION

For charging electrical energy stores, for example, NiCd or NiMH batteries, a charging device is used, which is operated on a supply voltage, and a charging voltage is provided to the energy store, which ensures that it is charged. To safeguard both the energy store as well as the charging device against extraordinary operating conditions, frequently only a very simple safety device is used, which operates according to the so-called “crowbar” principle. In this connection, a component of the charging device is deliberately destroyed when an extraordinary operating condition occurs, so that the charging device is disconnected and brought into a safe operating mode. The component to be destroyed may include a dedicated fuse. However, a component, for example, a diode or a transistor, which fills another function during the normal operation of the charging device, may be selectively destroyed by excessive voltage or excessive current.

In this case, it is believed to be disadvantageous that the charging device cannot easily be put back into operation after the destruction of the component. Furthermore, it is believed that it is not possible to verify that the disconnect mechanism is functional, for example, in the context of quality assurance. Thus, it is believed that there is always some uncertainty as to whether the disconnect mechanism is able to fulfill its function at all.

### SUMMARY OF THE INVENTION

An object of the exemplary embodiments and/or exemplary methods of the present invention is therefore to provide an indestructible disconnect mechanism for a switched-mode power supply.

The exemplary embodiments and/or exemplary methods of the present invention may achieve this objective using a circuit having the features described herein. Further descriptions herein describe advantageous specific embodiments.

A disconnect device according to the present invention for a switched-mode power supply, the switched-mode power supply including an activation device for a first transistor for generating a transformable voltage, includes a second transistor of the PNP type and a third transistor of the NPN type, the base of the second transistor being connected to the collector of the third transistor and the base of the third transistor being connected to the collector of the second transistor. Furthermore, the emitter of the third transistor is connected to ground and the emitter of the second transistor is connected to a control voltage terminal of the activation device, the control voltage terminal being set up for suppressing the generation of the voltage by the first transistor if the control voltage terminal is connected to ground, so that the generation of the voltage is suppressed if the base of the third transistor is acted upon by a voltage which exceeds a predetermined threshold value.

The described disconnect device made up of two transistors disconnects the switched-mode power supply reliably and effectively via the control voltage terminal when the base of the third transistor is connected to an adequately high cut-off voltage. In this case, the control voltage terminal also continues to be connected to ground when the cut-off voltage drops again. Only when the voltage present on the disconnect device has decayed sufficiently, for example, because the switched-mode power supply is disconnected, is the control voltage terminal separated from ground, making it possible for the switched-mode power supply to be switched on again. This forces the switched-mode power supply to be disconnected longer, which may increase the reliability of the switched-mode power supply and a consumer connected to it. For example, the disconnection may be initiated by a detected overtemperature, and the disconnection may last long enough that the element in question cools down to the extent that the switched-mode power supply may be operated again.

In a first specific embodiment, the control voltage terminal includes a control terminal of the first transistor. As a result, the disconnection may occur in any type of primary clocked switched-mode power supply, in particular those which are configured as self-oscillators.

In a second specific embodiment, the control voltage terminal includes a control terminal of a voltage source for providing an operating voltage for the activation device for the first transistor. As a result, a function of the activation device may be utilized, which stops the activation of the first transistor in the event of an undervoltage. As a result, the disconnect device may also be used in a switched-mode power supply which uses an integrated circuit as an activation device which has no dedicated input for disconnection and which also includes the first transistor in one specific embodiment.

A first capacitor may be connected between the emitter and the base of the PNP transistor and/or a second capacitor may be connected between the base and the emitter of the NPN transistor. As a result, the disconnect device may in each case be more resistant to interfering impulses.

A storage capacitor may be provided between the emitter of the second transistor and the emitter of the third transistor. As a result, a disconnection time may be extended, so that a disconnection of the switched-mode power supply will last for at least a predetermined time.

In one specific embodiment, an optocoupler is provided to separate one potential of the turn-off pulse from the disconnect device. This makes it possible to ensure operating reliability, for example, in a mains-operated charging device.

The exemplary embodiments and/or exemplary methods of the present invention will now be described in greater detail with reference to the appended drawings.

### BRIEF DESCRIPTION OF THE DRAWINGS

FIG. 1 shows a block diagram of a device having a switched-mode power supply.

FIG. 2 shows a circuit in the device from FIG. 1.

FIG. 3 shows a variation of the circuit of FIG. 2.

FIG. 4 shows another specific embodiment of a circuit in the device from FIG. 1.

FIG. 5 shows a variation of the circuit of FIG. 4.

### DETAILED DESCRIPTION

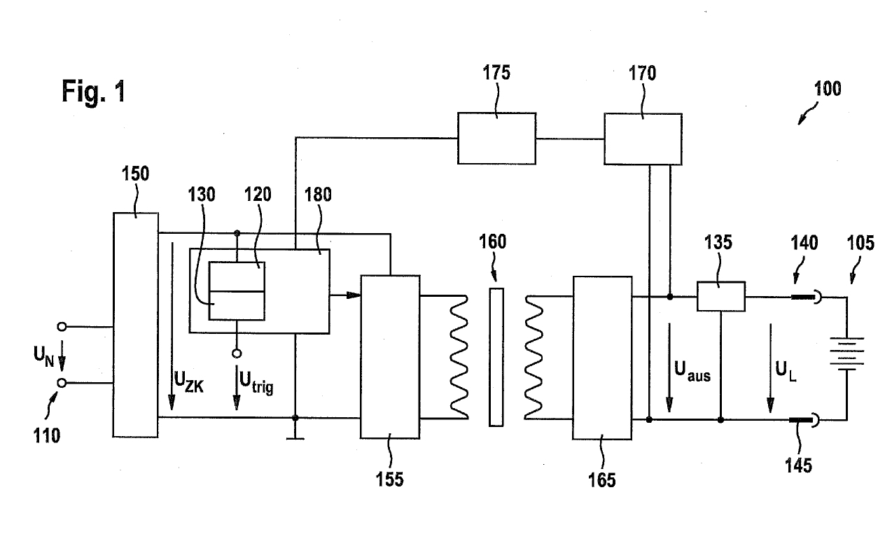

FIG. 1 shows a schematic block diagram of a device 100 and an energy store 105 which is connectable to device 100. Energy store 105 is a battery, for example, based on lithium ions or nickel metal hydride. Device 100 is a charging device for energy store 105.

Device 100 includes a mains connection 110, a rectifier 150, a switching device 155, a transformer 160, another rectifier 165, a control amplifier 170, an optocoupler 175 and a controller 180 having a disconnect device 130.

Mains connection 110 is used for connecting to a mains voltage U_{N} of an energy supply network, in particular an alternating voltage network having 110 V/60 Hz or 230 V/50 Hz. Mains connection 110 is connected to rectifier 150. Rectifier 150 filters and rectifies mains voltage U_{N} and, on this basis, provides intermediate circuit voltage U_{ZK}, which is a direct voltage.

Intermediate circuit voltage U_{ZK} feeds controller 180 including disconnect device 130 as well as switching device 155. Switching device 155 converts intermediate circuit voltage U_{ZK} into a voltage which is transformable by transformer 160 and provides the converted voltage to transformer 160. The provided voltage may have a rectangular, step, trapezoidal, sinusoidal or other form processable by transformer 160. In this case, typically, a frequency is used which is above the frequency of mains voltage U_{N}, for example, 50 kHz through 200 kHz, in particular 100 kHz. Transformer 160 transforms the converted voltage, which rectifier 165 converts into output voltage Uₐᵤₛ, which is provided to charge controller 135.

One output of charge controller 135 is led through to a first charging connection 140 of charging device 100; a second charging connection 145 is connected directly to rectifier 165. Energy store 105 is connectable to charging device 100 with the aid of corresponding charging connections 140, 145 in order to be charged on charging device 100. In one specific embodiment, charge controller 135 has a disconnect function in the event of an undervoltage. If output voltage Uₐᵤₛ drops below a predetermined value, charge controller 135 stops the charging of energy store 105. In one specific embodiment, energy store 105 is charged at a constant voltage. In this case, charge controller 135 may be omitted and charging voltage U_{L} is provided by output voltage Uₐᵤₛ. In other specific embodiments, multiple elements 120 through 135 may be integrated together into a single component.

Output voltage Uₐᵤₛ is monitored by control amplifier 170, which provides a signal as a function of output voltage Uₐᵤₛ that is provided to controller 180 with the aid of optocoupler 175. Based on the provided signal, controller 180 generates a control signal for switching device 155 in order to regulate the direct voltage generated by rectifier 165 to a predetermined voltage or the current provided by rectifier 165 to a predetermined current.

Disconnect device 130 is set up to be triggered with the aid of a cut-off voltage U_{trig}. If disconnect device 130 is triggered, it intervenes in the function of controller 180 in such a way that switching device 155 is no longer able to switch through, so that the energy transfer via transformer 160 is disrupted and output voltage Uₐᵤₛ is cut off. Cut-off voltage U_{trig} may be provided on the basis of, for example, an overvoltage, an undervoltage, an overcurrent, an undercurrent, an overtemperature and/or an undertemperature of any element on charging device 100.

In one specific embodiment, controller 180 is able to conduct a control voltage, provided by switching device 155 through controller 180, directly to ground. In another specific embodiment, controller 180 includes a voltage source 120 for providing an operating voltage for controller 180, and disconnect device 130 influences voltage source 120 in such a way that the provided operating voltage drops to such an extent that an undervoltage protection of controller 180 is activated, which interrupts the control voltage provided by switching device 155. In this case, a part of controller 180 in the form of an integrated circuit (IC) may be present and may be configured to be integrated with switching device 155. In this case, voltage source 120 for the operating voltage of integrated circuit 180 is not integrated and may be influenced by disconnect device 130.

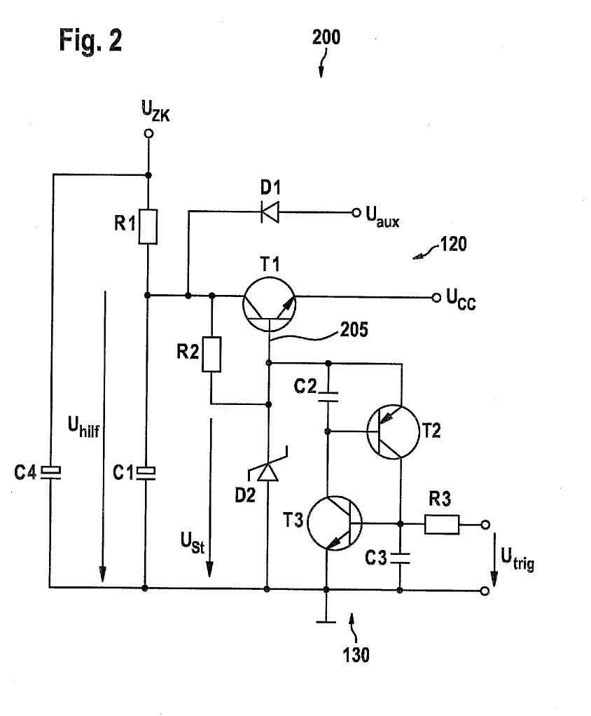

FIG. 2 shows a circuit 200 in charging device 100 from FIG. 1. Circuit 200 represents voltage source 120 and disconnect device 130 in controller 180 in FIG. 1. The specific embodiment of disconnect device 130 shown in FIG. 2 is in particular suitable when the activation of switching device 155 is carried out with the aid of a controller 180 configured as an integrated circuit. To cut switched-mode power supply 100 off, voltage source 120 is cut off so that remaining controller 180 detects an undervoltage and halts the activation of the switching device 155.

Voltage source 120 in FIG. 2 is essentially formed by an NPN transistor T1, a Zener diode D2 and a resistor R2. Disconnect device 130 is made up of transistors T2 and T3, capacitors C2 and C3, and a resistor R3.

Intermediate circuit voltage U_{ZK} is connected to the collector of NPN transistor T1 via a resistor R1 as an auxiliary voltage U_{hilf}. From the collector of NPN transistor T1, a capacitor C1, which may have an electrolytic capacitor having a high storage capacity, is connected to ground.

The emitter of NPN transistor T1 provides supply voltage Ucc. The provision takes place as a function of a control voltage Ust, which is present on the base of NPN transistor T1, here denoted as control voltage terminal 205. In order to generate a suitable control voltage U_{St}, resistor R2 is connected to ground in series with a Zener diode D2 from the collector of NPN transistor T1. A predetermined voltage drops across Zener diode D2 as long as auxiliary voltage U_{hilf} exceeds the predetermined voltage across the series circuit made up of resistor R2 and Zener diode D2. The base of NPN transistor T1 and control voltage terminal 205 is connected between resistor R2 and Zener diode D2.

NPN transistor T1 is generally operated with the aid of control voltage U_{St} in saturation, i.e., no limitation or regulation of supply voltage Ucc occurs. If NPN transistor T1 departs from this working point, a power loss within NPN transistor T1 is converted into heat. With the aid of diode D1, an auxiliary voltage Uₐᵤₓ is coupled to the collector of transistor T1. The amount of auxiliary voltage Uₐᵤₓ is generally ascertained empirically, and for reasons of safety, is selected around a predetermined amount of a few volts above the empirically ascertained voltage. A suitable selection of Zener diode D2 makes it possible to influence a working point of NPN transistor T1 with regard to a limiting behavior. This working point may be shifted by the circuit around transistors T2 and T3, so that NPN transistor T1 is increasingly limited after trigger voltage U_{trig} has risen above the predetermined threshold value.

The components of disconnect device 130 are connected between the base of NPN transistor T1 and ground. Transistor T2 is a PNP transistor, while transistor T3 is an NPN transistor. The base of transistor T2 is connected to the collector of transistor T3 and the base of transistor T3 is connected to the collector of transistor T2. The emitter of transistor T2 leads to the base of NPN transistor T1; the emitter of transistor T3 is connected to ground. Capacitors C2 and C3 are situated between the base and the emitter of transistor T2 and transistor T3. Cut-off voltage U_{trig} is coupled to the base of transistor T3 or to the collector of transistor T2 with the aid of resistor R3, resistor R3 being used to limit the current through the base-emitter path of transistor T3.

During normal operation of circuit 200, both transistors T2 and T3 block. If cut-off voltage U_{trig} exceeds a predetermined value, transistor T3 switches through and its collector-emitter path becomes conductive. This causes the base of transistor T2 to be connected to ground, so that transistor T2 also switches through and its collector-emitter path becomes conductive. This causes control voltage U_{St}, which is present on the emitter of transistor T2, to be conducted through to the collector of transistor T2 and thus to the base of transistor T3, so that transistor T3 remains in the conductive state, irrespective of whether cut-off voltage U_{trig} again drops below the predetermined value or not.

While transistors T2 and T3 are conductive, a current flows in parallel with Zener diode D2, so that voltage source 120 is detuned in such a way that control voltage U_{St} drops, causing NPN transistor T1 to block and supply voltage Ucc collapses to near 0.

Capacitors C2 and C3 of disconnect device 130 ensure that when circuit 200 is switched on, i.e., if intermediate circuit voltage U_{ZK} (and auxiliary voltage Uₐᵤₓ rise from 0, the two transistors T2 and T3 initially remain in the non-conductive state if cut-off voltage U_{trig} is below the predetermined value at this point in time.

In order to bring transistors T2 and T3 of triggered disconnect device 130 back to a non-conductive state, it is necessary to reduce control voltage U_{St}, from which the two transistors T2 and T3 are fed, to 0. For this purpose, intermediate circuit voltage U_{ZK} is cut off, for example, by separating charging device 100 on mains connection 110 from the energy supply network, or by preventing a main switch of device 100 from providing intermediate circuit voltage U_{ZK}. Transistors T2 and T3 remain in the conductive state until capacitor C1, which is connected in parallel to auxiliary voltage U_{hilf,} and capacitor C4, which is connected in parallel to the intermediate circuit voltage U_{ZK}, are discharged. The discharge process of capacitor C4 may last from a few seconds to several minutes. If during the discharge time, intermediate circuit voltage U_{ZK} is provided again, transistors T2 and T3 remain in the conductive state and supply voltage Ucc remains cut off.

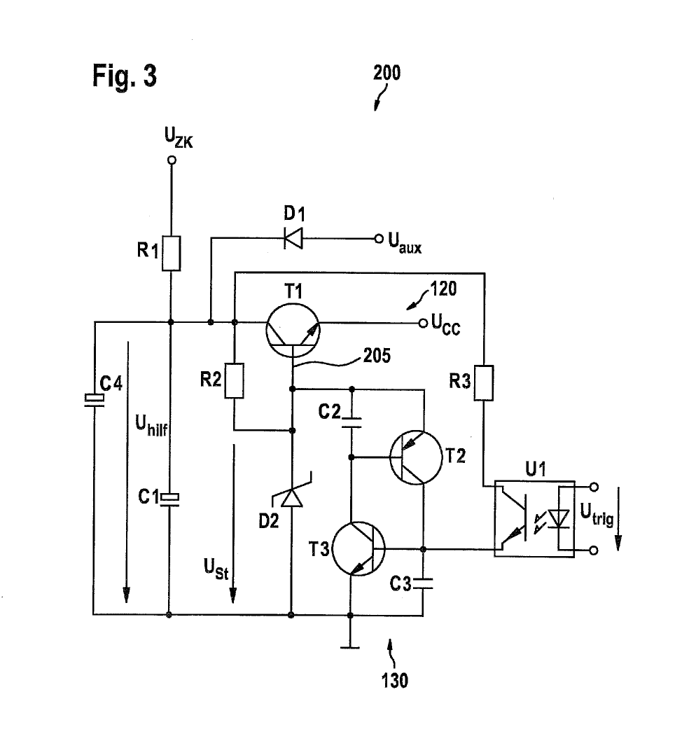

FIG. 3 shows a variation of circuit 200 from FIG. 1. In this case, cut-off voltage U_{trig} is decoupled from transistors T2 and T3 with the aid of an optocoupler U1. Optocoupler U1 includes a light-emitting diode that is controllable with the aid of cut-off voltage U_{trig}. The light-emitting diode acts on a phototransistor of optocoupler U1 until the phototransistor is activated and a conductive connection exists on its collector-emitter path. The emitter and the collector of the phototransistor are led through on optocoupler U1, the emitter being connected to the base of transistor T3 and the collector via resistor R3 being connected to auxiliary voltage U_{hilf} on the collector of NPN transistor T1. If the light-emitting diode in optocoupler U1 lights up, the base of NPN transistor T3 is connected to a potential that is derived from U_{hilf} and activates transistor T3. The remaining function of transistors T2 and T3 is described above with reference to FIG. 2. The use of optocoupler U1 electrically isolates cut-off voltage U_{trig} from the rest of circuit 200.

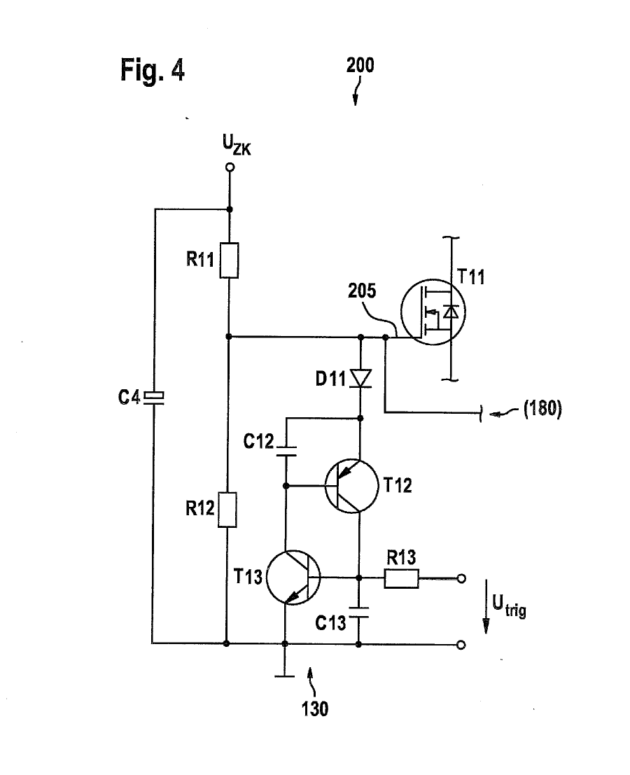

FIG. 4 shows another specific embodiment of a circuit 200 in the device from FIG. 1. Circuit 200 represents disconnect device 130 in controller 180 in FIG. 1; also shown are a terminal to a component of controller 180, which is not shown, and a FET transistor T11, which represents switching device 155 in FIG. 1. A gate terminal of FET transistor T11 forms control voltage terminal 205 in this case. FET transistor T11 may be a power transistor, through which flows a large portion of electrical power provided by switched-mode power supply 110. In particular, FET transistor T11 may be a MOSFET. In another specific embodiment, a thyristor or another electronic switching element may also be used in place of FET transistor T11.

The specific embodiment of disconnect device 130 shown in FIG. 4 may be used for disconnecting FET transistor T11 and it may be preferable if a different possibility for influencing controller 180 is not present. In order to switch off switched-mode power supply 100, the control terminal of FET transistor T11 is connected to ground, so that no more voltage is provided to transformer 160 and the transfer of energy through transformer 160 is stopped.

The remaining components shown correspond essentially to the components used in the specific embodiment of FIG. 2; however, they were marked with a preceding numeral 1 for the sake of clarity. In particular, shown disconnect device 130, made up of transistors T12 and T13 as well as capacitors C12 and C13 and resistor R13, corresponds to disconnect device 130 in FIG. 2 made up of transistors T2, T3 as well as capacitors C2, C3 and resistor R3.

The control voltage on control voltage terminal 205 is provided from intermediate circuit voltage U_{ZK} by a voltage divider with the aid of resistors R11 and R12. The emitter of PNP transistor T12 is connected to control voltage terminal 205 of FET transistor T11 with the aid of diode D11. A capacitor similar to C1 from FIG. 2 is not provided in the represented specific embodiment.

In a corresponding manner as described above with respect to the specific embodiment of FIG. 2, the control voltage on control voltage terminal 205 of FET transistor T11 is lowered by disconnect device 130 if cut-off voltage U_{trig} exceeds a predetermined value. This essentially switches off FET transistor T11, so that no more voltage is provided to transformer 160 and the transfer of energy through transformer 160 is stopped. The reduction is maintained, even if cut-off voltage U_{trig} drops below the predetermined value. To cancel the reduction, intermediate voltage U_{ZK} must initially be cut off.

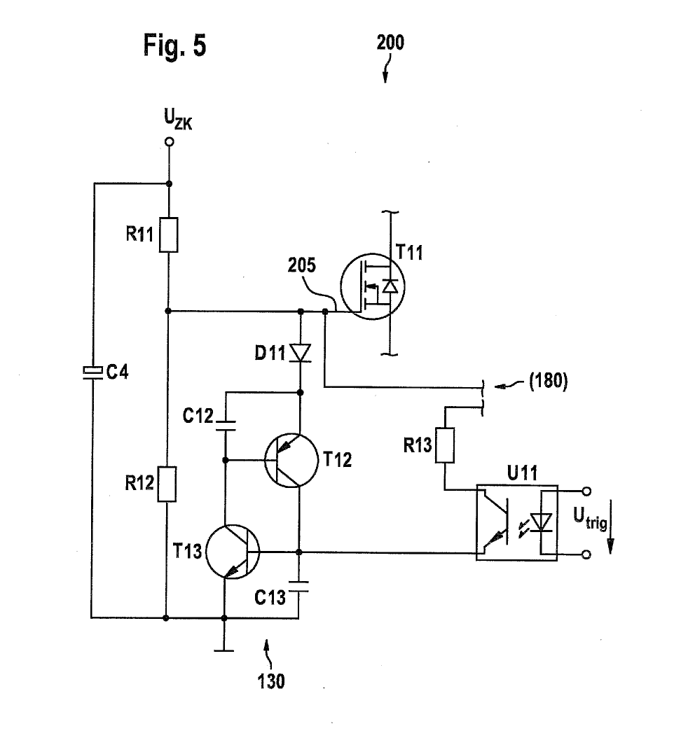

FIG. 5 shows a variation of circuit 200 from FIG. 4. In a manner similar to that which was explained above with reference to FIG. 3, an optocoupler U11 corresponding to optocoupler U1 is provided in order to isolate cut-off voltage U_{trig} electrically from the remaining elements of circuit 200.

1-7. (canceled)

8. A disconnect device for a switched-mode power supply, comprising:
a second transistor of the PNP type, wherein the switched-mode power supply includes an activation device for a first transistor for generating a transformable voltage; and
a third transistor of the NPN type;
wherein the base of the second transistor is connected to the collector of the third transistor,
wherein the base of the third transistor is connected to the collector of the second transistor,
wherein the emitter of the third transistor is connected to ground, and
wherein the emitter of the second transistor is connected to a control voltage terminal of the activation device, the control voltage terminal being set up for suppressing the generation of the voltage by the first transistor, if the control voltage terminal is connected to ground, so that the generation of the voltage is suppressed if the base of the third transistor is acted upon by a voltage which exceeds a predetermined threshold value.

9. The disconnect device of claim 8, wherein the control voltage terminal includes a control terminal of the first transistor.

10. The disconnect device of claim 8, wherein the control voltage terminal includes a control terminal of a voltage source for providing an operating voltage for the activation device for the first transistor.

11. The disconnect device of claim 8, wherein a first capacitor is connected between the emitter and the base of the PNP transistor.

12. The disconnect device of claim 8, wherein a second capacitor is connected between the base and the emitter of the NPN transistor.

13. The disconnect device of claim 8, further comprising:
a storage capacitor between the emitter of the second transistor and the emitter of the third transistor.

14. The disconnect device of claim 8, further comprising:
an optocoupler to separate a potential of the cut-off voltage from the disconnect device.
